(19) United States
(12) Patent Application Publication
(10) Pub. No.: US 2025/0329206 A1
(43) Pub. Date: Oct. 23, 2025

(54) Vending Kiosk Systems and Methods for Personalizing an Article

(71) Applicant: Erik Michael Schickling, Jupiter, FL (US)

(72) Inventor: Erik Michael Schickling, Jupiter, FL (US)

(21) Appl. No.: 18/641,318

(22) Filed: Apr. 19, 2024

(51) Int. Cl. G07F 11/16; G07F 9/00; G07F 11/72

(52) U.S. Cl. CPC G07F 11/1657; G07F 9/001; G07F 11/72

(57) ABSTRACT

This invention describes a system and method for marking articles using a vending kiosk system. The system includes a housing, a display with a graphic user interface for receiving personalization data, and a computing device for processing the personalization data. The system also includes a marking implement that is responsive to signals from the computing device, and one or more articles with a capture structure and a substantially planar surface, which are retained in a compartment of the housing. A conveyor system aligns the planar surface of the articles with the marking implement. A vacuum gripping system is electrically connected to the computing device and has an arm, a suction element, a vacuum source, and a valve. The suction element is removably connected to the planar surface of the articles, and the valve controls the suction between the suction element and the articles.

### BACKGROUND OF THE INVENTION

### 1. Field of the Invention

This invention relates, generally, to marking personalized articles, and in particular, to systems and methods for personalizing an article, from a vending kiosk.

### 2. Background Art

Conventional vending kiosks may be used for marking an article such as a pet tag or a license plate keychain, in an example, using various marking implement techniques such as stamping, imprinting, stylus engraving, and laser etching. Each of these marking implement techniques is configured to apply surface indicia such as text, an image, and/or a logo to the article. Souvenir kiosks in today's market are configured for personalizing primarily flat articles that are less susceptible to interfering with the marking components during the marking process. It would be more desirable for a vending kiosk system to be configured for user to have an option to select a 3-Dimensional article to personalize in addition to a flat article.

Currently, many publicly used kiosk marking machines are used to personalize souvenirs at amusement parks and at other high traffic tourist destinations. Some kiosk marking machines are operated when a user pays a fee, selects a desired article to be personalized within the kiosk from a display, enters the desired text and/or a pre-determined image for the article, and activates the marking system to personalize the article. Many of these predetermined images are generic symbols such as a basketball, a heart, a rainbow, a flower, or a smiley face, to name a few examples. These systems may store a variety of flat plates that are retained in columns that dispense to plate carriers that move to etching positions. An engraving stylus, for example, may be used to apply the desired text and/or image onto the top surface of the flat plate and then dispense the personalized flat plate to a dispensing port. It would be more desirable for a vending kiosk system to be configured to provide a user with more of a variety of articles as well as personalization options rather than a database of generic symbols applied to a flat plate.

However, in view of the prior art considered as a whole at the time the present invention was made; it was not obvious to those of ordinary skill in the pertinent art how the identified needs could be fulfilled.

### SUMMARY OF THE INVENTION

The long-standing but heretofore unfulfilled need for a system and method for marking articles using a vending kiosk system. The system includes a housing, a display with a graphic user interface for receiving personalization data, and a computing device for processing the personalization data. The system also includes a marking implement that is responsive to signals from the computing device, and one or more articles with a capture structure and a substantially planar surface, which are retained in a compartment of the housing. A conveyor system aligns the planar surface of the articles with the marking implement. A vacuum gripping system is electrically connected to the computing device and has an arm, a suction element, a vacuum source, and a valve. The suction element is removably connected to the planar surface of the articles, and the valve controls the suction between the suction element and the articles and which also includes improvements that overcome the limitations of prior vending kiosk systems, is now met by a new, useful, and non-obvious invention.

### BRIEF DESCRIPTION OF THE DRAWINGS

For a fuller understanding of the nature and objects of the invention, reference should be made to the following detailed description, taken in connection with the accompanying drawings, in which:

FIGS. 1 and 1A are a flow chart of a process for personalizing an article, in accordance with an embodiment;

FIG. 2 is a schematic block diagram illustrating components of the kiosk system having a suction element configured to connect to an article, in accordance with an embodiment;

FIG. 3 is a schematic block diagram illustrating components of the kiosk system having a suction element connected to an article, in accordance with an embodiment;

FIG. 4 is a schematic block diagram illustrating components of the kiosk system connecting the capture structure of the one or more articles to the conveyor system using the hingedly pivotable arm, in accordance with an embodiment;

FIG. 5 is a schematic block diagram illustrating components of the kiosk system aligning, by the computing device, the substantially planar surface of the one or more articles with the marking implement using a linear actuator of the conveyor system, in accordance with an embodiment;

FIG. 6 is a side cut-away view of a valve of the vacuum gripping system having a first orientation allowing ambient air to flow through the suction element to the vacuum source to form suction between the suction element and the substantially planar surface of the one or more articles, in accordance with an illustrative embodiment; and,

FIG. 7 is a side cut-away view of a valve of the vacuum gripping system having a second orientation configured to allow the ambient air to be expelled through the suction element to release the suction between the suction element and the substantially planar surface of the one or more articles, in accordance with an illustrative embodiment.

FIG. 8 illustrates an embodiment with the components of the kiosk system of FIG. 2 having a suction element configured to connect to an article using a telescoping arm, in accordance with an embodiment;

### DETAILED DESCRIPTION OF THE PREFERRED EMBODIMENT

To more fully understand the invention, reference is made to the accompanying drawings or figures. The invention is described in accordance with the aspects and embodiments in the following description with reference to the drawings or figures (FIG.), in which like numbers represent the same or similar elements. Understanding that these drawings are not to be considered limitations in the scope of the invention, the presently described aspects and embodiments and the presently understood best mode of the invention are described with additional detail through use of the accompanying drawings.

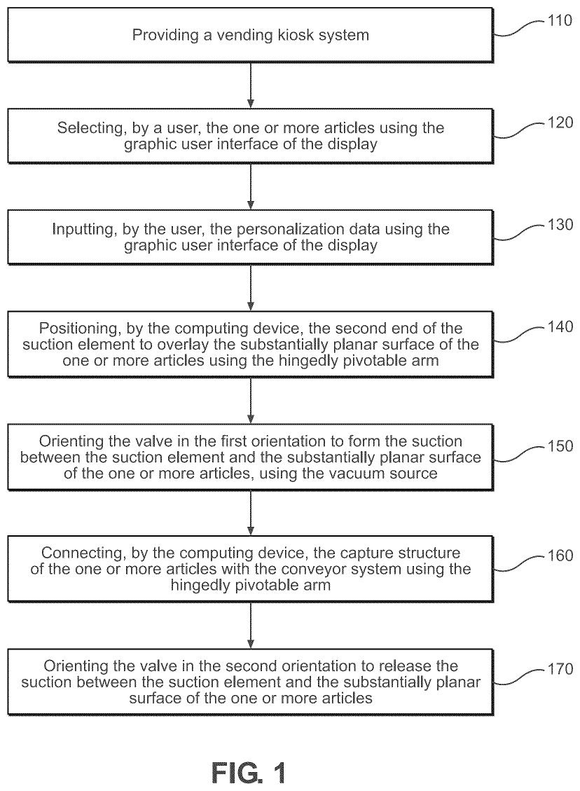

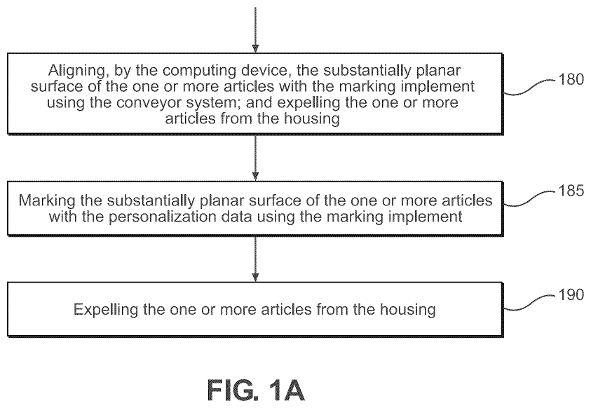

FIGS. 1 and 1A are a flowchart of an example method for personalizing an article. At step 110, providing a vending kiosk system, comprising a housing, a display having a graphic user interface, the graphic user interface of the display is configured to receive personalization data, a computing device, the computing device configured to receive the personalization data from the graphic user interface, a marking implement, the marking implement retained within the housing, the marking implement is responsive to one or more signals received from the computing device, one or more articles, the one or more articles retained in a compartment of the housing, the one or more articles having a capture structure, the one or more articles having a substantially planar surface, a conveyor system, the conveyor system is electrically connected to the computing device, the conveyor system is retained within the housing, the conveyor system is configured to align the substantially planar surface of the one or more articles with the marking implement when the conveyor system is connected to the capture structure of the one or more articles; and a vacuum gripping system, the vacuum gripping system is electrically connected to the computing device, the vacuum gripping system comprising a hingedly pivotable arm, a suction element, the suction element has a first end located opposite a second end, the first end of the suction element is connected to the hingedly pivotable arm, the second end of the suction element is removably connected to at least a portion of the substantially planar surface of the one or more articles, a vacuum source, the vacuum source is electrically connected to the computing device; and a valve, the valve having a first orientation allowing ambient air to flow through the suction element to the vacuum source to form suction between the suction element and the substantially planar surface of the one or more articles, the valve having a second orientation configured to allow the ambient air to be expelled through the suction element to release the suction between the suction element and the substantially planar surface of the one or more articles.

FIG. 1 shows at step 110, providing a vending kiosk system. At step 120, selecting, by a user, the one or more articles using the graphic user interface of the display. At step 130, inputting, by the user, the personalization data using the graphic user interface of the display. At step 140, positioning, by the computing device, the second end of the suction element to overlay the substantially planar surface of the one or more articles using the hingedly pivotable arm. At step 150, orienting the valve in the first orientation to form the suction between the suction element and the substantially planar surface of the one or more articles, using the vacuum source. At step 160, connecting, by the computing device, the capture structure of the one or more articles with the conveyor system using the hingedly pivotable arm. At step 170, orienting the valve in the second orientation to release the suction between the suction element and the substantially planar surface of the one or more articles.

FIG. 1A shows, at step 180, aligning, by the computing device, the substantially planar surface of the one or more articles with the marking implement using the conveyor system. At step 185, marking the substantially planar surface of the one or more articles with the personalization data using the marking implement. At step 190, expelling the one or more articles from the housing. In particular, the personalization vending system operates through a series of steps to customize one or more articles efficiently. Initially, at step 180, the system aligns the articles on a conveyor system. This alignment process, controlled by a computing device, ensures that the substantially planar surfaces of the articles are properly positioned to receive personalized markings. Following alignment, at step 185, the system proceeds to mark the articles with personalized data using a marking implement. This stage involves printing, engraving, or applying the desired customization onto the articles' planar surfaces. Once the personalization process is complete, at step 190, the system expels the personalized articles from the housing. This expulsion mechanism safely and efficiently removes the customized articles from the system, indicating their readiness for collection or further processing. Overall, this automated system streamlines the customization process, potentially enabling on-demand personalization in settings resembling vending machines for customized items.

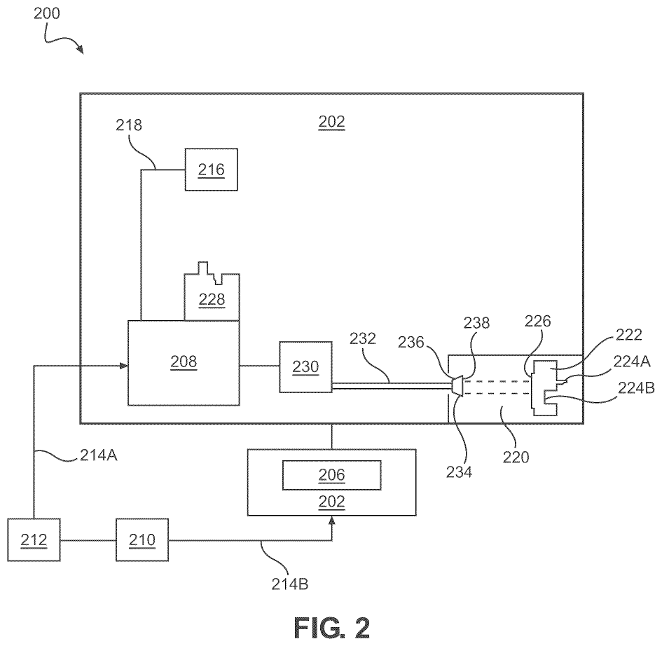

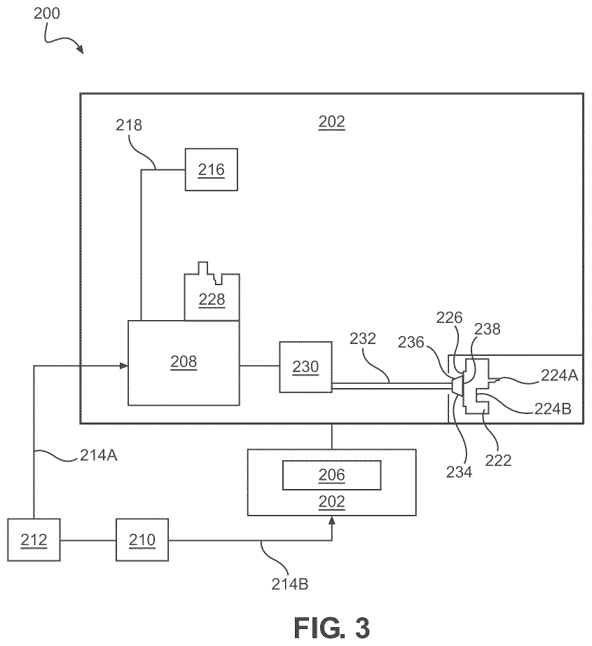

FIGS. 2-5 show a schematic block diagram illustrating components of kiosk system 200 that may be retained in housing 202. Display 204 has graphic user interface 206 configured to receive personalization data 214B from user 210. Computing device 208 is configured to receive personalization data 214B from graphic user interface 206. Marking implement 216 may be retained within housing 202. It is within the scope of this invention for marking implement 216 to include, but not be limited to, stamping, imprinting, stylus engraving, and laser etching. Marking implement 216 is responsive to one or more signals 218 received from computing device 208. One or more articles 222 may include, but no be limited to, a photo, a keychain, a license plate, an ornament, a magnet, a souvenir, a flat object, a 3D object, a promotional item, a sport item, an advertising item, a sporting item, and/or an animal figurine. One or more articles 222 may be retained in compartment 220 of housing 202. One or more articles 222 may have at least one capture structure. The capture structure may include recess 224B and/or protrusion 224A.

One or more articles 222 may have substantially planar surface 226.

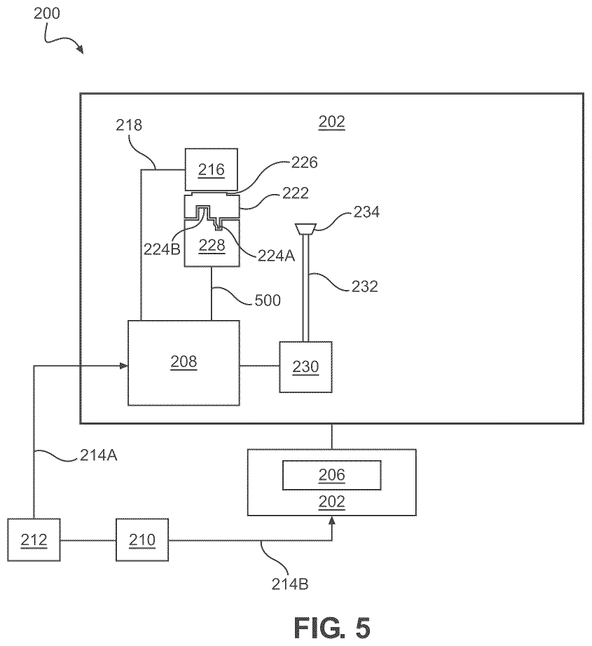

Conveyor system 228 is electrically connected to computing device 208. Conveyor system 228 is retained within housing 202. FIG. 5 best illustrates conveyor system 228 is configured to align substantially planar surface 226 of one or more articles 222 with marking implement 216 when conveyor system 228 is connected to a capture structure being protrusion 224A and/or recess 224B of one or more articles 222. It is within the scope of this invention for the conveyor system to activate linear actuator 500 (FIG. 5) when at least a portion of the capturing structure of one or more articles 222 is connected to the conveyer system. For example, the conveyer system may have a lock and key mechanism that is configured to conform to the capturing structure pattern of the one or more articles to activate the linear actuator to lengthen the one or more article 222 towards marking implement 216. Vacuum gripping system 230 is electrically connected to computing device 208. Vacuum gripping system 230 has hingedly pivotable arm 232 connected to suction element 234. Suction element 234 has first end 236 located opposite second end 238. First end 236 of suction element 234 is connected to hingedly pivotable arm 232. FIG. 2 best shows second end 238 of suction element 234 is configured to be removably connected to at least a portion of substantially planar surface 226 of one or more articles 222.

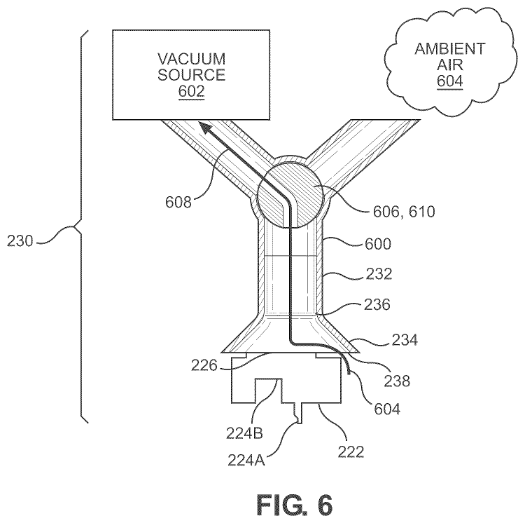

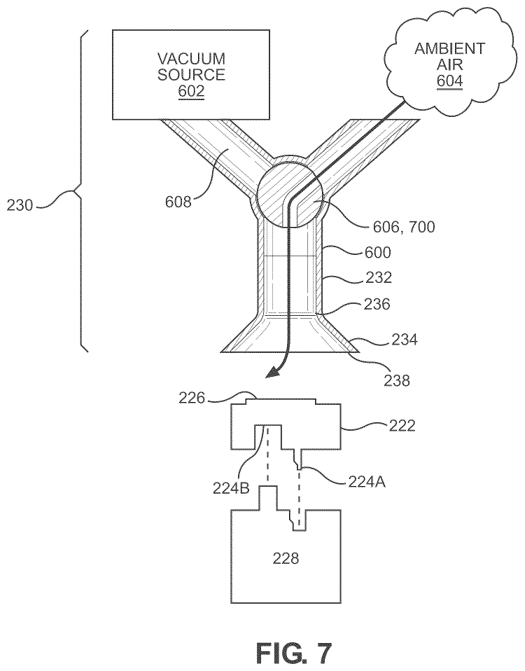

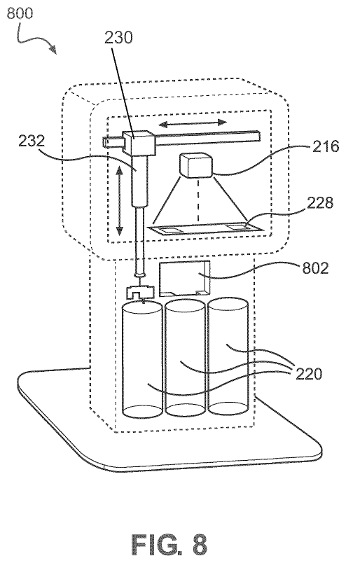

FIGS. 6 and 7 show vacuum source 602 electrically connected to computing device 208. Vacuum source 602 is connected to at least a portion of valve 600. It is within the scope of this invention for valve 600 to be a Y-valve and/or a 3-way ball valve. FIG. 6 shows valve 600 having first orientation 610 allowing ambient air 604 to flow 608 through suction element 234, through arm 232 that may be hingedly pivotable and/or telescoping (FIG. 8), through an opening of ball mechanism 606 of valve 600, to vacuum source 602 to form suction between suction element 234 and substantially planar surface 226 of one or more articles 222. FIG. 7 shows valve 600 having second orientation 700 configured to allow ambient air 604 to flow 702 through valve 600, through an opening of ball mechanism 606 of valve 600, through arm 232, and through suction element 234 to be expelled to release suction between suction element 234 and substantially planar surface 226 of one or more articles 222.

FIGS. 2-7 show suction element 234 being a cup. In an embodiment, the suction element may be a pad (not shown). The suction element 234 is depicted as a cup, serving as an example of one possible configuration within the personalization vending system. This cup-shaped suction element is designed to securely grasp and manipulate articles during the customization process. The choice of a cup-shaped suction element offers several advantages, including a stable and reliable grip on various types of articles, especially those with smooth or slightly curved surfaces. The cup-shaped suction element typically consists of a flexible material, such as silicone or rubber, that can conform to the contours of the article's surface, ensuring a tight seal for effective suction. This design allows the suction cup to create a vacuum when pressed against the article's surface, generating enough suction force to hold the article securely in place during handling and customization. The cup-shaped suction element is attached to the hingedly pivotable arm 232 of the vacuum gripping system 230, forming an integral part of the system's manipulation mechanism. The hinged arm allows for versatile movement, enabling the suction cup to be precisely positioned and adjusted as needed to grasp different articles. It's worth noting that while FIGS. 2-7 specifically depict the suction element as a cup, the system allows for flexibility in design. As mentioned in the embodiment, the suction element could alternatively be a pad, although this configuration is not explicitly shown in the figures. A pad-shaped suction element may have a different surface area and shape, potentially offering advantages for specific types of articles or customization tasks. Overall, the depiction of the suction element as a cup in FIGS. 2-7 highlights one possible configuration within the personalization vending system, demonstrating how the system can adapt to different suction element designs based on the requirements of the customization process.

Referring again to FIGS. 2-5, vending kiosk system 200 may have computing device 208 in communication with database 242 of images. Database 242 of images is in communication with electronic device 212 of user 210. Personalization data 214A may include images from database 242 that is sent to computing device 208. Images may be taken from a smart phone, for example, and stored in database 242 which are then marked on one or more articles 222. This database serves as a repository for a wide range of images that can be used for personalization purposes. Users, such as 210 interacting with electronic devices like smartphones or tablets, can access this database through electronic device 212. The electronic device establishes communication with the database, allowing users to select images to be used for personalization. When a user selects an image from the database, it becomes part of the personalization data 214A, which is then transmitted to the computing device 208. This personalization data includes the selected image or images along with any additional customization instructions provided by the user. The images stored in the database can originate from various sources. For instance, users may upload their own images from their electronic devices, capturing moments, artwork, or designs that they wish to imprint on articles. Additionally, the database may include a curated selection of pre-existing images, graphics, or designs offered by the vending kiosk system operator or third-party providers. These images could encompass a diverse range of content, from generic patterns and symbols to licensed artwork or brand logos. Once the personalization data, including the selected images, is received by the computing device 208, it initiates the customization process. The computing device coordinates with other components of the system, such as the display interface, marking implement, and conveyor system, to apply the selected images onto one or more articles 222. The integration of the database of images with the vending kiosk system enhances its versatility and appeal to users. It allows for a highly customizable experience, where users can personalize articles with images that hold personal significance or resonate with their preferences. Whether it's adding a favorite photograph, a custom design, or a branded logo, the availability of diverse images in the database enriches the personalization options offered by the vending kiosk system.

FIG. 5 shows vending kiosk system 200, having arm 232 being hingedly pivotable 400 and/or rotatable to relocate one or more articles 222 from compartment 220 within housing 202 to a dock 240 of conveyor system 228. In FIG. 5, the vending kiosk system 200 is depicted with an arm 232 that is hingedly pivotable 400 and/or rotatable. This mechanism plays a crucial role in relocating one or more articles 222 from the compartment 220 within the housing 202 to a dock 240 of the conveyor system 228. The hingedly pivotable and/or rotatable arm 232 provides flexibility and precision in handling the articles within the vending kiosk system. By being hingedly pivotable, the arm can swing or pivot around a fixed point, enabling it to reach various positions within the housing. This movement allows the arm to access articles stored in different areas of the compartment 220, ensuring efficient retrieval. Additionally, the rotatable aspect of the arm further enhances its maneuverability. It enables the arm to rotate around its axis, expanding its range of motion and facilitating precise positioning of the articles. This rotational capability is particularly useful when aligning the articles with the conveyor system's dock 240 for further processing. The combined hingedly pivotable and rotatable design of the arm provides versatility in handling articles of different shapes, sizes, and orientations within the vending kiosk system. It allows for smooth and controlled movement, minimizing the risk of damage to the articles during handling. Furthermore, this mechanism enhances the automation of the customization process, streamlining the workflow within the vending kiosk system. By efficiently relocating the articles from the compartment to the conveyor system's dock, it ensures a seamless transition between stages of the customization process, ultimately improving productivity and user experience. The hingedly pivotable and/or rotatable arm depicted in FIG. 5 plays a role in the functionality of the vending kiosk system, enabling the smooth and precise handling of articles as they are processed for customization.

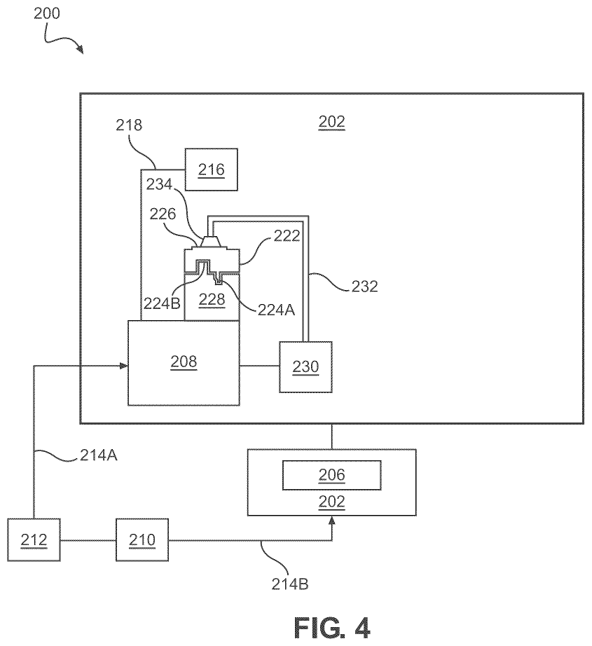

In FIG. 8, an embodiment of the kiosk system 800 depicted in FIG. 2 is illustrated, featuring a suction element configured to connect to an article using the arm 232 to telescope rather than hingedly pivot as depicted in FIGS. 2-5 and in particular, FIG. 4. This configuration represents a variation in the design of the system, offering alternative mechanisms for manipulating articles during the customization process. The telescoping arm is a component of this embodiment, providing adjustable length to reach articles stored within the system's compartment 220. By extending and retracting, the telescoping arm can access articles located at varying distances, enabling efficient retrieval and manipulation. Attached to the telescoping arm is a suction element, similar to the one described earlier, which is designed to securely grasp and hold articles during handling. This suction element creates a vacuum seal when pressed against the surface of the article, ensuring a stable grip without causing damage. The integration of the telescoping arm 232 with the suction element enhances the system's versatility and adaptability. It allows for precise positioning of the suction element relative to the articles, accommodating different sizes and shapes effectively. The telescoping arm's adjustable length enables it to reach articles positioned at different depths within the compartment, ensuring comprehensive coverage and accessibility. This embodiment of the kiosk system offers an alternative approach to article manipulation, complementing the functionality provided by other mechanisms such as the hingedly pivotable arm illustrated in previous figures. By incorporating a telescoping arm with a suction element, the system can cater to a broader range of articles and customization requirements, enhancing its overall utility and effectiveness.

The vending kiosk system incorporates several essential components to facilitate the customization and delivery of personalized articles to users. At its core is the laser printer or engraver 216, a sophisticated machinery equipped with laser technology capable of printing or engraving personalized designs onto various materials. This component works in tandem with the conveyor system 228, which serves to transport articles through the customization process with precision and consistency. Controlled by the computing device 208, the conveyor system ensures that articles are aligned correctly with the laser printer or engraver for accurate customization. Once personalized, the articles are expelled from the vending kiosk through the vending slot 802, strategically positioned for users to conveniently retrieve their customized items. Together, these components form a cohesive system that automates the process of customizing and delivering personalized articles, providing users with a seamless and user-friendly experience.

In some aspects, the techniques described herein relate to a vending kiosk system, wherein the personalization data is an image uploaded from a database of an electronic device of a user.

In some aspects, the techniques described herein relate to a method of personalizing an article; providing a vending kiosk system, including: a housing; a display having a graphic user interface, the graphic user interface of the display is configured to receive personalization data; a computing device, the computing device configured to receive the personalization data from the graphic user interface; a marking implement, the marking implement retained within the housing, the marking implement is responsive to one or more signals received from the computing device; one or more articles, the one or more articles retained in a compartment of the housing, the one or more articles having a capture structure, the one or more articles having a substantially planar surface; a conveyor system, the conveyor system is electrically connected to the computing device, the conveyor system is retained within the housing, the conveyor system is configured to align the substantially planar surface of the one or more articles with the marking implement when the conveyor system is connected to the capture structure of the one or more articles; and a vacuum gripping system, the vacuum gripping system is electrically connected to the computing device, the vacuum gripping system including: a hingedly pivotable arm; a suction element, the suction element has a first end located opposite a second end, the first end of the suction element is connected to the hingedly pivotable arm, the second end of the suction element is removably connected to at least a portion of the substantially planar surface of the one or more articles; a vacuum source, the vacuum source is electrically connected to the computing device; and a valve, the valve having a first orientation allowing ambient air to flow through the suction element to the vacuum source to form suction between the suction element and the substantially planar surface of the one or more articles, the valve having a second orientation configured to allow the ambient air to be expelled through the suction element to release the suction between the suction element and the substantially planar surface of the one or more articles; selecting, by a user, the one or more articles using the graphic user interface of the display; inputting, by the user, the personalization data using the graphic user interface of the display; positioning, by the computing device, the second end of the suction element to overlay the substantially planar surface of the one or more articles using the hingedly pivotable arm; orienting the valve in the first orientation to form the suction between the suction element and the substantially planar surface of the one or more articles, using the vacuum source; connecting, by the computing device, the capture structure of the one or more articles to the conveyor system using the hingedly pivotable arm; orienting the valve in the second orientation to release the suction between the suction element and the substantially planar surface of the one or more articles; aligning, by the computing device, the substantially planar surface of the one or more articles with the marking implement using the conveyor system; marking the substantially planar surface of the one or more articles with the personalization data using the marking implement; and expelling the one or more articles from the housing.

In some aspects, the techniques described herein relate to a method, further including uploading, by the user, the personalization data being an image from a database of an electronic device of the user.

In some aspects, the techniques described herein relate to a vending kiosk system for marking an article, including: a housing; a display having a graphic user interface, the graphic user interface of the display is configured to receive personalization data; a computing device, the computing device configured to receive the personalization data from the graphic user interface; a marking implement, the marking implement retained within the housing, the marking implement is responsive to one or more signals received from the computing device; one or more articles, the one or more articles retained in a compartment of the housing, the one or more articles having a capture structure, the one or more articles having a substantially planar surface; a conveyor system, the conveyor system is electrically connected to the computing device, the conveyor system is retained within the housing, the conveyor system is configured to align the substantially planar surface of the one or more articles with the marking implement when the conveyor system is connected to the capture structure of the one or more articles; and a vacuum gripping system, the vacuum gripping system is electrically connected to the computing device, the vacuum gripping system including: a hingedly pivotable arm; a suction element, the suction element has a first end located opposite a second end, the first end of the suction element is connected to the hingedly pivotable arm, the second end of the suction element is removably connected to at least a portion of the substantially planar surface of the one or more articles; a vacuum source, the vacuum source is electrically connected to the computing device; and a valve, the valve having a first orientation allowing ambient air to flow through the suction element to the vacuum source to form suction between the suction element and the substantially planar surface of the one or more articles, the valve having a second orientation configured to allow the ambient air to be expelled through the suction element to release the suction between the suction element and the substantially planar surface of the one or more articles.

In some aspects, the techniques described herein relate to a vending kiosk system, wherein the capture structure is a recess.

In some aspects, the techniques described herein relate to a vending kiosk system, wherein the capture structure is a protrusion.

In some aspects, the techniques described herein relate to a vending kiosk system, wherein the suction element is a cup.

In some aspects, the techniques described herein relate to a vending kiosk system, wherein the suction element is a pad.

In some aspects, the techniques described herein relate to a vending kiosk system, wherein the vacuum source is a pump.

In some aspects, the techniques described herein relate to a vending kiosk system, wherein the vacuum source is a vacuum blower.

In some aspects, the techniques described herein relate to a vending kiosk system, wherein the vacuum source is a venturi system.

In some aspects, the techniques described herein relate to a vending kiosk system, wherein the computing device is in communication with a database of images, the database of the images is in communication with an electronic device.

In some aspects, the techniques described herein relate to a vending kiosk system, wherein the hingedly pivotable arm is rotatable.

In some aspects, the techniques described herein relate to a vending kiosk system, wherein the personalization data is an image uploaded from a database of an electronic device of a user.

In some aspects, the techniques described herein relate to a kiosk system for personalizing an article, including: a computing device, the computing device configured to receive personalization data from an interface; a marking implement, the marking implement is responsive to one or more signals received from the computing device; one or more articles, the one or more articles having a capture structure, the one or more articles having a marking surface; a conveyor system, the conveyor system is electrically connected to the computing device, the conveyor system is configured to align the marking surface of the one or more articles with the marking implement when the conveyor system is connected to the capture structure of the one or more articles; and a vacuum gripping system, the vacuum gripping system is electrically connected to the computing device, the vacuum gripping system including: an arm; a suction element, the suction element has a first end located opposite a second end, the first end of the suction element is connected to the arm, the second end of the suction element is removably connected to at least a portion of the marking surface of the one or more articles; a vacuum source, the vacuum source is electrically connected to the computing device; and a valve, the valve having a first orientation allowing ambient air to flow through the suction element to the vacuum source to form suction between the suction element and the marking surface of the one or more articles, the valve having a second orientation configured to allow the ambient air to be expelled through the suction element to release the suction between the suction element and the marking surface of the one or more articles.

In some aspects, the techniques described herein relate to a kiosk system, wherein the capture structure is a recess.

In some aspects, the techniques described herein relate to a kiosk system, wherein the capture structure is a protrusion.

In some aspects, the techniques described herein relate to a kiosk system, wherein the suction element is a cup.

In some aspects, the techniques described herein relate to a kiosk system, wherein the suction element is a pad.

In some aspects, the techniques described herein relate to a kiosk system, wherein the computing device is in communication with a database of images, the database of the images is in communication with an electronic device.

In some aspects, the techniques described herein relate to a kiosk system, wherein the personalization data is an image uploaded from a database of an electronic device of a user.

A vacuum gripping mechanism may operate by utilizing the principles of fluid dynamics and suction. For example, a low-pressure environment is created within the suction element, relative to the atmospheric pressure surrounding the article to be grasped. This pressure difference creates a vacuum, which is then utilized to securely grip the article. The vacuum is generated by the use of a vacuum pump, or in some cases, a venturi effect, which draws air out of the area between the suction element and the article to form an air tight seal. The vacuum level may be precisely controlled, enabling the suction element to grasp articles of varying shapes and sizes with a consistent and reliable grip. The vacuum level is maintained by controlling the flow of ambient air into the suction element through the use of any valve such as a plurality of one-way valves, a 3-way ball valve, and/or a Y-valve, which may be configured to prevent the loss of vacuum and ensure the continued grip of the object.

In an embodiment, the computing device may have a processor and operating system. The processor is coupled to memory through a bus. The operations of the vacuum source are performed by execution of instructions by the computing device. According to an embodiment, such a bus may also be coupled to a database retaining images from an electronic device including, but not limited to, a cell phone, a smart phone, a tablet, and/or a computer.

Clause 1. A method of personalizing an article; providing a vending kiosk system, comprising: a housing; a display having a graphic user interface, the graphic user interface of the display is configured to receive personalization data; a computing device, the computing device configured to receive the personalization data from the graphic user interface; a marking implement, the marking implement retained within the housing, the marking implement is responsive to one or more signals received from the computing device; one or more articles, the one or more articles retained in a compartment of the housing, the one or more articles having a capture structure, the one or more articles having a substantially planar surface; a conveyor system, the conveyor system is electrically connected to the computing device, the conveyor system is retained within the housing, the conveyor system is configured to align the substantially planar surface of the one or more articles with the marking implement when the conveyor system is connected to the capture structure of the one or more articles; and a vacuum gripping system, the vacuum gripping system is electrically connected to the computing device, the vacuum gripping system comprising: a hingedly pivotable arm; a suction element, the suction element has a first end located opposite a second end, the first end of the suction element is connected to the hingedly pivotable arm, the second end of the suction element is removably connected to at least a portion of the substantially planar surface of the one or more articles; a vacuum source, the vacuum source is electrically connected to the computing device; and, a valve, the valve having a first orientation allowing ambient air to flow through the suction element to the vacuum source to form suction between the suction element and the substantially planar surface of the one or more articles, the valve having a second orientation configured to allow the ambient air to be expelled through the suction element to release the suction between the suction element and the substantially planar surface of the one or more articles; selecting, by a user, the one or more articles using the graphic user interface of the display; inputting, by the user, the personalization data using the graphic user interface of the display; positioning, by the computing device, the second end of the suction element to overlay the substantially planar surface of the one or more articles using the hingedly pivotable arm; orienting the valve in the first orientation to form the suction between the suction element and the substantially planar surface of the one or more articles, using the vacuum source; connecting, by the computing device, the capture structure of the one or more articles to the conveyor system using the hingedly pivotable arm; orienting the valve in the second orientation to release the suction between the suction element and the substantially planar surface of the one or more articles; aligning, by the computing device, the substantially planar surface of the one or more articles with the marking implement using the conveyor system; marking the substantially planar surface of the one or more articles with the personalization data using the marking implement; and, expelling the one or more articles from the housing.

Clause 2. The method of clause 1, further comprising uploading, by the user, the personalization data being an image from a database of an electronic device of the user.

Clause 3. A vending kiosk system for marking an article, comprising: a housing; a display having a graphic user interface, the graphic user interface of the display is configured to receive personalization data; a computing device, the computing device configured to receive the personalization data from the graphic user interface; a marking implement, the marking implement retained within the housing, the marking implement is responsive to one or more signals received from the computing device; one or more articles, the one or more articles retained in a compartment of the housing, the one or more articles having a capture structure, the one or more articles having a substantially planar surface; a conveyor system, the conveyor system is electrically connected to the computing device, the conveyor system is retained within the housing, the conveyor system is configured to align the substantially planar surface of the one or more articles with the marking implement when the conveyor system is connected to the capture structure of the one or more articles; and a vacuum gripping system, the vacuum gripping system is electrically connected to the computing device, the vacuum gripping system comprising: a hingedly pivotable arm; a suction element, the suction element has a first end located opposite a second end, the first end of the suction element is connected to the hingedly pivotable arm, the second end of the suction element is removably connected to at least a portion of the substantially planar surface of the one or more articles; a vacuum source, the vacuum source is electrically connected to the computing device; and a valve, the valve having a first orientation allowing ambient air to flow through the suction element to the vacuum source to form suction between the suction element and the substantially planar surface of the one or more articles, the valve having a second orientation configured to allow the ambient air to be expelled through the suction element to release the suction between the suction element and the substantially planar surface of the one or more articles.

Clause 4. The vending kiosk system of clause 3, wherein the capture structure is a recess.

Clause 5. The vending kiosk system of clause 3, wherein the capture structure is a protrusion.

Clause 6. The vending kiosk system of clause 3, wherein the suction element is a cup.

Clause 7. The vending kiosk system of clause 3, wherein the suction element is a pad.

Clause 8. The vending kiosk system of clause 3, wherein the vacuum source is a pump.

Clause 9. The vending kiosk system of clause 3, wherein the vacuum source is a vacuum blower.

Clause 10. The vending kiosk system of clause 3, wherein the vacuum source is a venturi system.

Clause 11. The vending kiosk system of clause 3, wherein the computing device is in communication with a database of images, the database of the images is in communication with an electronic device.

Clause 12. The vending kiosk system of clause 3, wherein the hingedly pivotable arm is rotatable.

Clause 13. The vending kiosk system of clause 3, wherein the personalization data is an image uploaded from a database of an electronic device of a user.

Clause 14. A kiosk system for personalizing an article, comprising: a computing device, the computing device configured to receive personalization data from an interface; a marking implement, the marking implement is configured to receive one or more signals transmitted from the computing device; one or more articles, the one or more articles having a capture structure, the one or more articles having a marking surface; a conveyor system, the conveyor system is electrically connected to the computing device, the conveyor system having a dock; an arm, the arm is electrically connected to the computing device, the arm is configured to connect the capture structure of the one or more articles to the dock of the conveyor system; and, a linear actuator, the linear actuator is connected to the conveyor system, the linear actuator is configured to extend to align the marking surface of the one or more articles with the marking implement when the dock of the conveyor system is connected to the capture structure of the one or more articles.

Clause 15. The kiosk system of clause 14, wherein the capture structure is a recess.

Clause 16. The kiosk system of clause 14, wherein the capture structure is a protrusion.

Clause 17. The kiosk system of clause 14, wherein the computing device is in communication with a database of images, the database of the images is in communication with an electronic device.

Clause 18. The kiosk system of clause 14, wherein the personalization data is an image uploaded from a database of an electronic device of a user.

Clause 19. The kiosk system of clause 14, wherein the arm is rotatable.

Clause 20. The kiosk system of clause 14, wherein the arm is hingedly pivotable.

The described embodiments are illustrative of the invention and are not exhaustive thereof. As work order generation systems evolve, further steps may be required in future embodiments of the invention but all such future embodiments are within the scope of this invention.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the description is intended to cover all of the generic and specific features of the invention herein described, and all statements of the scope of the invention that, as a matter of language, might be said to fall therebetween.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein regarding illustrations and/or block diagrams of methods, computer systems, and computing devices according to embodiments of the invention. It will be understood that each block in the block diagrams, and combinations of the blocks, can be implemented by the computer-readable instructions (e.g., the program code).

The computer-readable instructions are provided to the processor of a general purpose computer, special purpose computer, or other programmable data processing apparatus (e.g., the computing device) to produce a machine, such that the instructions, which execute via the processor of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention.

It will be understood that each block and combinations of blocks in the diagrams, can be implemented by the computer readable program instructions. The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

Another embodiment of the invention provides a method that performs the process steps on a subscription, advertising, and/or fee basis. That is, a service provider can offer to assist in one or more of the method steps. In this case, the service provider can create, maintain, and/or support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

Now that the invention has been described,

What is claimed is:

1. A method of personalizing an article;
providing a vending kiosk system, comprising:
a housing;
a display having a graphic user interface, the graphic user interface of the display is configured to receive personalization data;
a computing device, the computing device configured to receive the personalization data from the graphic user interface;
a marking implement, the marking implement retained within the housing, the marking implement is responsive to one or more signals received from the computing device;
one or more articles, the one or more articles retained in a compartment of the housing, the one or more articles having a capture structure, the one or more articles having a substantially planar surface;
a conveyor system, the conveyor system is electrically connected to the computing device, the conveyor system is retained within the housing, the conveyor system is configured to align the substantially planar surface of the one or more articles with the marking implement when the conveyor system is connected to the capture structure of the one or more articles; and
a vacuum gripping system, the vacuum gripping system is electrically connected to the computing device, the vacuum gripping system comprising:
a hingedly pivotable arm;
a suction element, the suction element has a first end located opposite a second end, the first end of the suction element is connected to the hingedly pivotable arm, the second end of the suction element is removably connected to at least a portion of the substantially planar surface of the one or more articles;
a vacuum source, the vacuum source is electrically connected to the computing device; and,
a valve, the valve having a first orientation allowing ambient air to flow through the suction element to the vacuum source to form suction between the suction element and the substantially planar surface of the one or more articles, the valve having a second orientation configured to allow the ambient air to be expelled through the suction element to release the suction between the suction element and the substantially planar surface of the one or more articles;
selecting, by a user, the one or more articles using the graphic user interface of the display;
inputting, by the user, the personalization data using the graphic user interface of the display;
positioning, by the computing device, the second end of the suction element to overlay the substantially planar surface of the one or more articles using the hingedly pivotable arm;
orienting the valve in the first orientation to form the suction between the suction element and the substantially planar surface of the one or more articles, using the vacuum source;
connecting, by the computing device, the capture structure of the one or more articles to the conveyor system using the hingedly pivotable arm;
orienting the valve in the second orientation to release the suction between the suction element and the substantially planar surface of the one or more articles;
aligning, by the computing device, the substantially planar surface of the one or more articles with the marking implement using the conveyor system;
marking the substantially planar surface of the one or more articles with the personalization data using the marking implement; and,
expelling the one or more articles from the housing.

2. The method of claim 1, further comprising uploading, by the user, the personalization data being an image from a database of an electronic device of the user.

3. A vending kiosk system for marking an article, comprising:
a housing;
a display having a graphic user interface, the graphic user interface of the display is configured to receive personalization data;
a computing device, the computing device configured to receive the personalization data from the graphic user interface;
a marking implement, the marking implement retained within the housing, the marking implement is responsive to one or more signals received from the computing device;
one or more articles, the one or more articles retained in a compartment of the housing, the one or more articles having a capture structure, the one or more articles having a substantially planar surface;
a conveyor system, the conveyor system is electrically connected to the computing device, the conveyor system is retained within the housing, the conveyor system is configured to align the substantially planar surface of the one or more articles with the marking implement when the conveyor system is connected to the capture structure of the one or more articles; and
a vacuum gripping system, the vacuum gripping system is electrically connected to the computing device, the vacuum gripping system comprising:
a hingedly pivotable arm;
a suction element, the suction element has a first end located opposite a second end, the first end of the suction element is connected to the hingedly pivotable arm, the second end of the suction element is removably connected to at least a portion of the substantially planar surface of the one or more articles;
a vacuum source, the vacuum source is electrically connected to the computing device; and
a valve, the valve having a first orientation allowing ambient air to flow through the suction element to the vacuum source to form suction between the suction element and the substantially planar surface of the one or more articles, the valve having a second orientation configured to allow the ambient air to be expelled through the suction element to release the suction between the suction element and the substantially planar surface of the one or more articles.

4. The vending kiosk system of claim 3, wherein the capture structure is a recess.

5. The vending kiosk system of claim 3, wherein the capture structure is a protrusion.

6. The vending kiosk system of claim 3, wherein the suction element is a cup.

7. The vending kiosk system of claim 3, wherein the suction element is a pad.

8. The vending kiosk system of claim 3, wherein the vacuum source is a pump.

9. The vending kiosk system of claim 3, wherein the vacuum source is a vacuum blower.

10. The vending kiosk system of claim 3, wherein the vacuum source is a venturi system.

11. The vending kiosk system of claim 3, wherein the computing device is in communication with a database of images, the database of the images is in communication with an electronic device.

12. The vending kiosk system of claim 3, wherein the hingedly pivotable arm is rotatable.

13. The vending kiosk system of claim 3, wherein the personalization data is an image uploaded from a database of an electronic device of a user.

14. A kiosk system for personalizing an article, comprising:
a computing device, the computing device configured to receive personalization data from an interface;
a marking implement, the marking implement is configured to receive one or more signals transmitted from the computing device;
one or more articles, the one or more articles having a capture structure, the one or more articles having a marking surface;
a conveyor system, the conveyor system is electrically connected to the computing device, the conveyor system having a dock;
an arm, the arm is electrically connected to the computing device, the arm is configured to connect the capture structure of the one or more articles to the dock of the conveyor system; and,
a linear actuator, the linear actuator is connected to the conveyor system, the linear actuator is configured to extend to align the marking surface of the one or more articles with the marking implement when the dock of the conveyor system is connected to the capture structure of the one or more articles.

15. The kiosk system of claim 14, wherein the capture structure is a recess.

16. The kiosk system of claim 14, wherein the capture structure is a protrusion.

17. The kiosk system of claim 14, wherein the computing device is in communication with a database of images, the database of the images is in communication with an electronic device.

18. The kiosk system of claim 14, wherein the personalization data is an image uploaded from a database of an electronic device of a user.

19. The kiosk system of claim 14, wherein the arm is rotatable.

20. The kiosk system of claim 14, wherein the arm is hingedly pivotable.
